(19) United States
(12) Patent Application Publication
(10) Pub. No.: US 2024/0332689 A1
(43) Pub. Date: Oct. 3, 2024

(54) POWER STORAGE MODULE AND MANUFACTURING METHOD FOR THE SAME

(71) Applicant: Prime Planet Energy & Solutions, Inc., Tokyo (JP)

(72) Inventors: Shimpei KONDO, Nagoya-shi (JP); Toshiyuki KAWAI, Nagoya-shi (JP); Takahisa MATSUTA, Okazaki-shi (JP)

(21) Appl. No.: 18/617,765

(22) Filed: Mar. 27, 2024

(30) Foreign Application Priority Data
Mar. 30, 2023 (JP) 2023-055989

(51) Int. Cl. H01M 50/209; H01G 11/10; H01G 11/22; H01G 11/84; H01M 4/02; H01M 50/51

(52) U.S. Cl. CPC H01M 50/209; H01M 4/02; H01M 50/51; H01G 11/10; H01G 11/22; H01G 11/84; H01M 2004/021; H01M 2004/027

(57) ABSTRACT

A power storage module disclosed herein includes a plurality of power storage devices. A low-temperature region with relatively low temperature and a high-temperature region with relatively high temperature exist in the power storage module when the plurality of power storage devices are charged and discharged, and in a first power storage device disposed in the low-temperature region among the plurality of power storage devices, the filling density of a negative electrode active material layer is lower than that in a second power storage device disposed in the high-temperature region.

### CROSS REFERENCE TO RELATED APPLICATION

This application claims the benefit of priority to Japanese Patent Application No. 2023-055989 filed on Mar. 30, 2023. The entire contents of this application are hereby incorporated herein by reference.

### BACKGROUND OF THE DISCLOSURE

### 1. Field

The present disclosure relates to a power storage module including a plurality of power storage devices and a manufacturing method for the same.

### 2. Background

A power storage module in which a plurality of power storage devices (unit cells) are electrically connected to each other has been widely used conventionally in a power source for driving a vehicle and the like. Conventional technical literatures related to this include Japanese Patent Application Publication No. 2021-44212, Japanese Patent Application Publication No. 2022-81868, Japanese Patent Application Publication No. 2012-221816, and Japanese Patent Application Publication No. 2015-90794.

For example, Japanese Patent Application Publication No. 2021-44212 discloses a power storage module including a plurality of submodules and a housing that accommodates the plurality of submodules at predetermined positions. In Japanese Patent Application Publication No. 2021-44212, each of the plurality of submodules includes a cell group in which the plurality of power storage devices (unit cells) are arranged, and a restriction member that restricts the cell group by operating a restriction pressure in an arrangement direction. Inside the housing, a region where temperature tends to become relatively low exists. The submodule disposed in the region where temperature tends to become relatively low is configured so that the restriction pressure of the restriction member becomes relatively lower than the other submodules. According to Japanese Patent Application Publication No. 2021-44212, making the restriction pressure on the power storage device low in the region where high-rate durability tends to decrease (the temperature tends to become low) can equalize the high-rate durability of the plurality of power storage devices (increase in resistance when high-rate charging and discharging are repeated).

### SUMMARY

In the art according to Japanese Patent Application Publication No. 2021-44212, the restriction pressure cannot be made different among the plurality of power storage devices included in one cell group. Therefore, according to the present inventors' examination, if a temperature distribution occurs inside the cell group, it may be difficult to equalize the high-rate durability among the plurality of power storage devices. In addition, since the restriction member is necessary for each cell group, the restriction members become bulky, which may result in the decrease in volume energy density of the entire power storage module, and in a case of mounting the power storage module on a moving body such as a vehicle, for example, the weight increases, which may result in the deterioration in fuel efficiency.

The present disclosure has been made in view of the above circumstances, and a main object thereof is to provide a power storage module with a novel structure that can equalize the high-rate durability among a plurality of power storage devices and a manufacturing method for the same.

The present disclosure provides a power storage module including a plurality of power storage devices, in which each of the plurality of power storage devices includes a positive electrode and a negative electrode, the negative electrode includes a negative electrode active material layer including a negative electrode active material, a low-temperature region with relatively low temperature and a high-temperature region with relatively high temperature exist in the power storage module when the plurality of power storage devices are charged and discharged, and in a first power storage device disposed in the low-temperature region among the plurality of power storage devices, a filling density of the negative electrode active material layer is lower than that in a second power storage device disposed in the high-temperature region.

Moreover, the present disclosure provides a manufacturing method for a power storage module including a plurality of power storage devices, in which each of the plurality of power storage devices includes a positive electrode and a negative electrode and the negative electrode includes a negative electrode active material layer including a negative electrode active material. This manufacturing method includes: a preparing step of preparing, as the plurality of power storage devices, a first power storage device in which a filling density of the negative electrode active material layer is relatively low and a second power storage device in which the filling density of the negative electrode active material layer is relatively high; a temperature distribution predicting step of predicting a temperature distribution inside the power storage module when the plurality of power storage devices are charged and discharged; and a constructing step of constructing the power storage module by disposing the first power storage device in a low-temperature region with relatively low temperature and disposing the second power storage device in a high-temperature region with relatively high temperature, based on the temperature distribution.

The present inventors' various examinations indicate that the power storage device in which the filling density of the negative electrode active material layer is low is superior relatively to the power storage device in which the filling density of the negative electrode active material layer is high, in terms of the high-rate durability. In view of this, in the present disclosure, the power storage device in which the filling density is relatively low (the high-rate durability is excellent) is disposed in the low-temperature region in which the high-rate durability tends to decrease. Thus, the high-rate durability of the plurality of power storage devices can be equalized. Furthermore, the high-rate durability of the entire power storage module can be improved. Since it is unnecessary to consider the concept of “cell group” that is given in the art disclosed in Japanese Patent Application Publication No. 2021-44212, the high-rate durability of the individual power storage device can be adjusted flexibly. Additionally, since the number of restriction members can be reduced compared to the art disclosed in Japanese Patent Application Publication No. 2021-44212, the volume energy density or fuel efficiency can also be improved.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating a power storage module according to an embodiment;

FIG. 2 is a perspective view schematically illustrating a secondary battery in FIG. 1;

FIG. 3 is a schematic longitudinal cross-sectional view taken along line III-III in FIG. 2;

FIG. 4 is a schematic view illustrating a structure of an electrode body in FIG. 3;

FIG. 5 is a plan view schematically illustrating the power storage module in FIG. 1 and a cooling device;

FIG. 6 is a plan view schematically illustrating a power storage module according to a first modification;

FIG. 7 is a plan view schematically illustrating a power storage module according to a second modification;

FIG. 8 is a plan view schematically illustrating a power storage module according to a third modification; and

FIG. 9 is a plan view schematically illustrating a power storage module according to a fourth modification.

### DETAILED DESCRIPTION OF THE PREFERRED EMBODIMENTS

Hereinafter, preferred embodiments of the art disclosed herein will be described with reference to the drawings as appropriate. Matters that are other than matters particularly mentioned in the present specification and that are necessary for the implementation of the present disclosure (for example, the general configuration and manufacturing process of a power storage module and a power storage device that do not characterize the present disclosure) can be grasped as design matters of those skilled in the art based on the prior art in the relevant field. A power storage module disclosed herein can be implemented on the basis of the disclosure of the present specification and common technical knowledge in the relevant field.

Note that in the drawings below, the members and parts with the same operation are denoted by the same reference sign and the overlapping description may be omitted or simplified. Moreover, in the present specification, the notation “A to B” for a range signifies a value more than or equal to A and less than or equal to B, and is meant to encompass also the meaning of being “preferably more than A” and “preferably less than B”.

### [Power Storage Module]

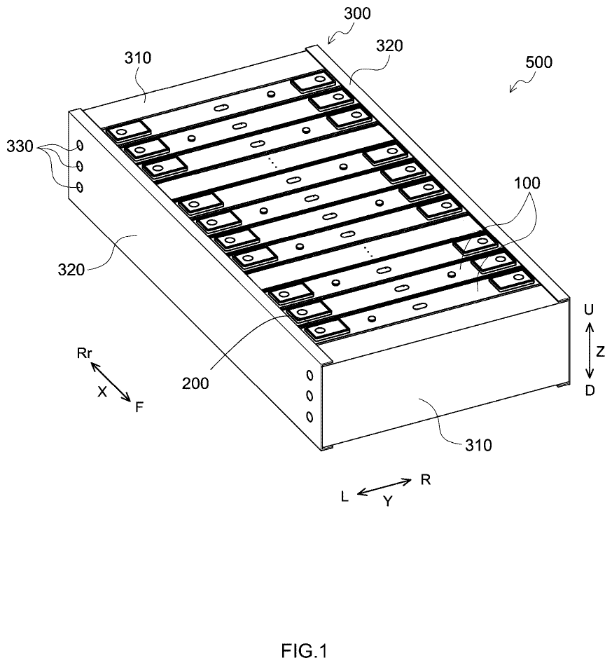

FIG. 1 is a perspective view schematically illustrating a power storage module 500. The power storage module 500 here includes a plurality of power storage devices (typically, electricity storage devices) 100, a plurality of spacers 200, and a restriction mechanism 300. However, the plurality of spacers 200 and the restriction mechanism 300 are not essential and may be omitted in another embodiment.

In the following description, reference signs L, R, F, Rr, U, and D in the drawings respectively denote left, right, front, rear, up, and down, and reference signs X, Y, and Z in the drawings respectively denote a short side direction of the power storage device 100, a long side direction that is orthogonal to the short side direction, and an up-down direction. The short side direction X also corresponds to an arrangement direction of the power storage devices 100. These directions are defined however for convenience of explanation, and do not limit the manner in which the power storage module 500 is disposed.

The restriction mechanism 300 is a member that restricts the plurality of power storage devices 100. Here, the number of restriction mechanism 300 is one. The restriction mechanism 300 here is configured to apply uniform restriction pressure on all of the power storage devices 100 and the spacers 200 from the arrangement direction X. The restriction mechanism 300 includes a pair of end plates 310, a pair of side plates 320, and a plurality of screws 330. The pair of end plates 310 and the pair of side plates 320 can be grasped as a housing that accommodates the plurality of power storage devices 100. The pair of end plates 310 and the pair of side plates 320 are preferably made of a metal.

The pair of end plates 310 are disposed at both ends of the power storage module 500 in the arrangement direction X. The pair of end plates 310 hold the plurality of power storage devices 100 and the plurality of spacers 200 therebetween in the arrangement direction X. The pair of side plates 320 link between the pair of end plates 310. The pair of side plates 320 are fixed to the end plates 310 by the plurality of screws 330 so that a restriction load is generally 10 to 15 kN, for example. Thus, the uniform restriction load is applied on the plurality of power storage devices 100 from the arrangement direction X and accordingly, the plurality of power storage devices 100 are held integrally. The structure of the restriction mechanism is, however, not limited to this example. In another example, the restriction mechanism 300 may alternatively include a plurality of restriction bands, bind bars, or the like instead of the side plates 320.

The spacers 200 are each disposed between the plurality of power storage devices 100 in the arrangement direction X here. That is to say, in the arrangement direction X, the power storage devices 100 and the spacers 200 are arranged alternately. However, in a case where the power storage module 500 does not include the spacer 200, the power storage devices 100 that are adjacent in the arrangement direction X may be in contact (direct contact) with each other. The spacer 200 preferably includes a part with a porous structure through which a fluid (typically, gas such as air) can pass.

The power storage device 100 is a device capable of being repeatedly charged and discharged. Note that in the present specification, the term “power storage device” refers to a concept encompassing secondary batteries such as lithium ion secondary batteries and nickel-hydrogen batteries and capacitors such as lithium ion capacitors and electrical double-layer capacitors. Here, the plurality of power storage devices 100 are arranged along the arrangement direction X (in other words, a thickness direction X of the power storage device 100) between the pair of end plates 310. The plurality of power storage devices 100 are preferably restricted by the restriction mechanism 300. The shape, the size, the number, and the like of the plurality of power storage devices 100 are not limited to the aspect disclosed in FIG. 1, and can be changed as appropriate.

Although not illustrated here, when the power storage module 500 is used, the plurality of power storage devices 100 are electrically connected to each other by a conductive member such as a busbar. The connection method is not limited in particular and may be, for example, series connection, parallel connection, multiple series-multiple parallel connection, or the like. In a preferred aspect, the plurality of power storage devices 100 are connected to each other in series. Thus, the output characteristic can be suitably improved to the level suitable for the use in a moving body such as a vehicle. In the case of series connection, the performance deterioration of some power storage devices 100 tends to lead to the performance deterioration of the entire power storage module 500. Thus, it is particularly effective to apply the art disclosed herein.

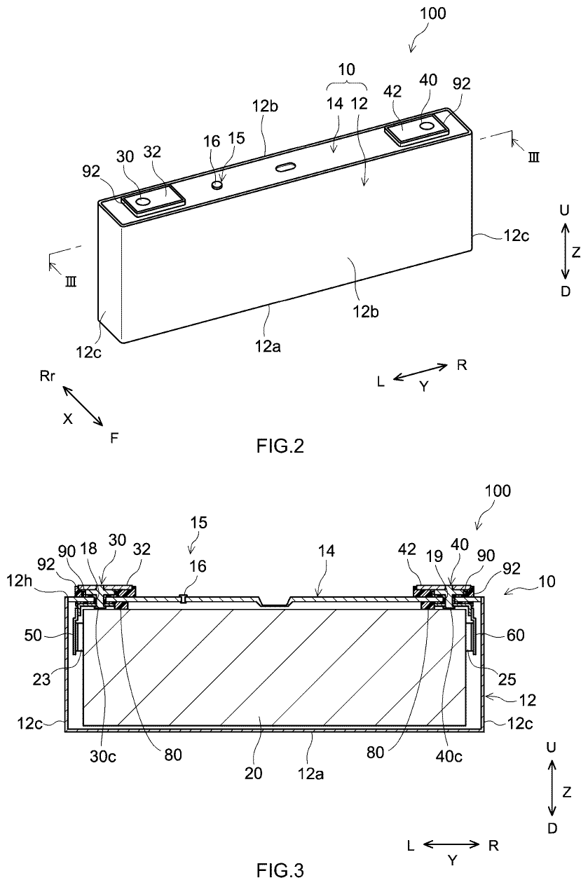

FIG. 2 is a perspective view of the power storage device 100. As illustrated in FIG. 1 and FIG. 2, every power storage device 100 has a flat and rectangular shape, and has the same shape here. The plurality of power storage devices 100 are arranged so that long side walls 12b to be described below are parallel to each other. The plurality of power storage devices 100 here are arranged in the arrangement direction X so that the long side walls 12b face each other through the spacer 200.

FIG. 3 is a schematic longitudinal cross-sectional view taken along line III-III in FIG. 2. As illustrated in FIG. 3, the power storage device 100 here includes a battery case 10, an electrode body 20, a positive electrode terminal 30, and a negative electrode terminal 40. Although not illustrated, the power storage device 100 further includes a nonaqueous electrolyte solution here. The power storage device 100 is configured so that the electrode body 20 and the nonaqueous electrolyte solution are accommodated in the battery case 10 to which the positive electrode terminal 30 and the negative electrode terminal 40 are attached. The power storage device 100 is typically a nonaqueous electrolyte solution secondary battery, and is a lithium ion secondary battery here. When the power storage device 100 is the nonaqueous electrolyte solution secondary battery (in particular, lithium ion secondary battery), it is particularly effective to apply the art disclosed herein.

The battery case 10 is a container that accommodates the electrode body 20 and the nonaqueous electrolyte solution. As illustrated in FIG. 2, the external shape of the battery case 10 here is a flat and bottomed cuboid shape (rectangular shape). A conventionally used material can be used for the battery case 10, without particular limitations. The battery case 10 is made of, for example, aluminum, an aluminum alloy, iron, an iron alloy, or the like. As illustrated in FIG. 3, the battery case 10 includes an exterior body 12 having an opening 12h, and a sealing plate (lid body) 14 that seals the opening 12h. As illustrated in FIG. 2, the exterior body 12 includes a bottom wall 12a with a substantially rectangular shape including long sides and short sides, the pair of long side walls 12b extending from the long sides of the bottom wall 12a and facing each other, and a pair of short side walls 12c extending from the short sides of the bottom wall 12a and facing each other. The long side wall 12b has a flat shape.

The sealing plate 14 is a plate-shaped member. The sealing plate 14 is substantially rectangular in shape. As illustrated in FIG. 3, the sealing plate 14 is attached to the exterior body 12 so as to cover the opening 12h of the exterior body 12. The battery case 10 is unified in a manner that the sealing plate 14 is joined (preferably, joined by welding) to a periphery of the opening 12h of the exterior body 12. The battery case 10 is hermetically sealed (closed). The sealing plate 14 is provided with a liquid injection hole 15 and two terminal extraction holes 18 and 19. The liquid injection hole 15 is a hole for injecting the nonaqueous electrolyte solution after the sealing plate 14 is assembled to the exterior body 12. The liquid injection hole 15 is sealed by a sealing member 16. The terminal extraction holes 18 and 19 penetrate the sealing plate 14 in the up-down direction Z.

The positive electrode terminal 30 is disposed on one end part of the sealing plate 14 in the long side direction Y (left end part in FIG. 2 and FIG. 3), and the negative electrode terminal 40 is disposed on the other end part of the sealing plate 14 in the long side direction Y (right end part in FIG. 2 and FIG. 3). As illustrated in FIG. 3, the positive electrode terminal 30 and the negative electrode terminal 40 are respectively inserted to the terminal extraction holes 18 and 19 and extend to the outside from the inside of the sealing plate 14. The positive electrode terminal 30 and the negative electrode terminal 40 are here caulked to a peripheral part of the sealing plate 14 that surrounds the terminal extraction holes 18 and 19 by a caulking process. Caulking parts 30c and 40c are formed at an end part of the positive electrode terminal 30 and the negative electrode terminal 40 on the exterior body 12 side (lower end part in FIG. 3). Thus, the positive electrode terminal 30 and the negative electrode terminal 40 are fixed to the sealing plate 14.

As illustrated in FIG. 3, the positive electrode terminal 30 is electrically connected to a positive electrode tab group 23 of the electrode body 20 through a positive electrode current collecting part 50 inside the exterior body 12. The positive electrode terminal 30 is insulated from the sealing plate 14 by an internal insulation member 80 and a gasket 90. The negative electrode terminal 40 is electrically connected to a negative electrode tab group 25 of the electrode body 20 through a negative electrode current collecting part 60 inside the exterior body 12. The negative electrode terminal 40 is insulated from the sealing plate 14 by the internal insulation member 80 and the gasket 90.

As illustrated in FIG. 2 and FIG. 3, a positive electrode external conductive member 32 and a negative electrode external conductive member 42, each having a plate shape, are attached to an external surface of the sealing plate 14. The positive electrode external conductive member 32 is electrically connected to the positive electrode terminal 30. The negative electrode external conductive member 42 is electrically connected to the negative electrode terminal 40. The positive electrode external conductive member 32 and the negative electrode external conductive member 42 are members to which the conductive member such as a busbar that electrically connects the plurality of power storage devices 100 to each other is attached. The positive electrode external conductive member 32 and the negative electrode external conductive member 42 are insulated from the sealing plate 14 by an external insulation member 92. For example, in the adjacent power storage devices 100 in the arrangement direction X, the positive electrode external conductive member 32 of one power storage device 100 and the negative electrode external conductive member 42 of the other power storage device 100 are electrically connected to each other by the busbar or the like so that the power storage devices 100 are connected in series in the power storage module 500.

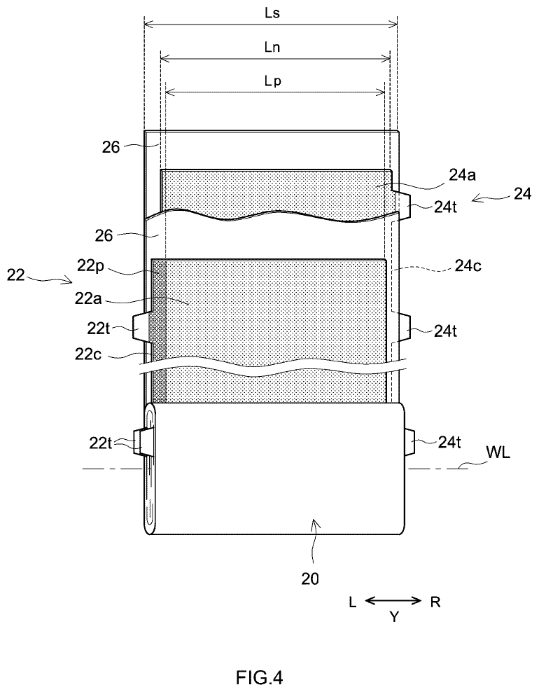

FIG. 4 is a schematic view illustrating a structure of the electrode body 20. As illustrated in FIG. 4, the electrode body 20 includes a positive electrode 22, a negative electrode 24, and a separator 26. Here, the electrode body 20 is a wound electrode body in which the positive electrode 22 with a band shape and the negative electrode 24 with a band shape are stacked through the separator 26 with a band shape and wound using a winding axis WL as a center. The external shape of the electrode body 20 is a flat shape. In this case, the electrode body 20 is disposed inside the exterior body 12 so that the winding axis WL is substantially parallel to the long side direction Y In another embodiment, however, the electrode body 20 may be disposed inside the exterior body 12 so that the winding axis WL is substantially parallel to the up-down direction Z. Moreover, the electrode body 20 may be a stack type electrode body formed in a manner that a plurality of square (typically, rectangular) positive electrodes and a plurality of square (typically, rectangular) negative electrodes are stacked in an insulated state.

The structure of the positive electrode 22 may be similar to the conventional one. Here, the positive electrode 22 includes a positive electrode current collector 22c, and a positive electrode active material layer 22a and a positive electrode protection layer 22p that are fixed on at least one surface of the positive electrode current collector 22c. However, the positive electrode protection layer 22p is not essential, and can be omitted in another embodiment. The positive electrode current collector 22c has a band shape. The positive electrode current collector 22c is preferably made of a metal, and more preferably made of a metal foil. Here, the positive electrode current collector 22c is an aluminum foil.

At one end part of the positive electrode current collector 22c in the long side direction Y (left end part in FIG. 4), a plurality of positive electrode tabs 22t are provided. The plurality of positive electrode tabs 22t protrude toward one side in the long side direction Y (left side in FIG. 4). The plurality of positive electrode tabs 22t protrude in the long side direction Y relative to the separator 26. The positive electrode tab 22t constitutes a part of the positive electrode current collector 22c here, and is made of a metal foil (aluminum foil). The plurality of positive electrode tabs 22t are stacked at one end part in the long side direction Y (left end part in FIG. 4), and form the positive electrode tab group 23. The positive electrode tab group 23 is electrically connected to the positive electrode terminal 30 through the positive electrode current collecting part 50.

The positive electrode active material layer 22a is provided to have a band shape on one surface or both surfaces (here, both surfaces) of the positive electrode current collector 22c along a longitudinal direction of the positive electrode current collector 22c. The positive electrode active material layer 22a includes a positive electrode active material that is capable of reversibly storing and releasing charge carriers. Examples of the positive electrode active material include a lithium transition metal complex oxide. The positive electrode active material layer 22a may contain an optional component other than the positive electrode active material, for example, various additive components such as a binder or a conductive material.

The positive electrode protection layer 22p is provided at a border part between the positive electrode current collector 22c and the positive electrode active material layer 22a in the long side direction Y The positive electrode protection layer 22p is provided to have a band shape along the positive electrode active material layer 22a. The positive electrode protection layer 22p contains inorganic filler (for example, alumina). The positive electrode protection layer 22p may contain an optional component other than the inorganic filler, such as a conductive material, a binder, or various additive components.

The negative electrode 24 includes a negative electrode current collector 24c, and a negative electrode active material layer 24a that is fixed on at least one surface of the negative electrode current collector 24c. The negative electrode current collector 24c has a band shape. The negative electrode current collector 24c is preferably made of a metal, and more preferably made of a metal foil. Here, the negative electrode current collector 24c is a copper foil.

At one end part of the negative electrode current collector 24c in the long side direction Y (right end part in FIG. 4), a plurality of negative electrode tabs 24t are provided. The plurality of negative electrode tabs 24t protrude toward one side in the long side direction Y (right side in FIG. 4). The plurality of negative electrode tabs 24t protrude in the long side direction Y relative to the separator 26. The negative electrode tab 24t constitutes a part of the negative electrode current collector 24c here, and is made of a metal foil (copper foil). The plurality of negative electrode tabs 24t are stacked at one end part in the long side direction Y (right end part in FIG. 4), and form the negative electrode tab group 25. The negative electrode tab group 25 is provided at a position that is symmetrical to the positive electrode tab group 23 in the long side direction Y The negative electrode tab group 25 is electrically connected to the negative electrode terminal 40 through the negative electrode current collecting part 60.

The negative electrode active material layer 24a is provided to have a band shape on one surface or both surfaces (here, both surfaces) of the negative electrode current collector 24c along a longitudinal direction of the negative electrode current collector 24c. A length Ln of the negative electrode active material layer 24a in the long side direction Y is preferably more than or equal to a length Lp of the positive electrode active material layer 22a in the long side direction Y The negative electrode active material layer 24a includes a negative electrode active material that is capable of reversibly storing and releasing the charge carriers. Examples of the negative electrode active material include a carbon material such as graphite, hard carbon, or soft carbon, a compound containing silicon (Si-containing material), and the like. Graphite may be either natural graphite or artificial graphite, and may be amorphous carbon covering graphite in which graphite is covered with an amorphous carbon material.

Although not limited in particular, the ratio of the negative electrode active material in the negative electrode active material layer 24a is preferably 90 mass % or more, and more preferably 95 to 99 mass %, for example. The negative electrode active material layer 24a may contain an optional component other than the negative electrode active material, for example, various additive components such as a binder, a thickener, or a dispersing agent. Examples of the binder include styrene butadiene rubber (SBR), polyvinylidene fluoride (PVdF), and the like. Examples of the thickener include carboxymethyl cellulose (CMC) and the like.

The separator 26 is disposed between the positive electrode 22 and the negative electrode 24. The separator 26 is a member that insulates the positive electrode 22 and the negative electrode 24. The structure of the separator 26 may be similar to the conventional one. A length Ls of the separator 26 in the long side direction Y is preferably more than or equal to the length Ln of the negative electrode active material layer 24a in the long side direction Y The separator 26 is suitably a porous sheet (microporous film) made of resin including polyolefin resin such as polyethylene (PE) or polypropylene (PP), for example. The separator 26 may include a functional layer (for example, adhesive layer, heat resistance layer (HRL), or the like) on a surface of the porous sheet made of resin.

The structure of the nonaqueous electrolyte solution may be similar to the conventional one. The nonaqueous electrolyte solution typically contains a nonaqueous solvent and a supporting salt (electrolyte salt). Examples of the nonaqueous solvent include carbonates such as ethylene carbonate, dimethyl carbonate, and ethyl methyl carbonate. Examples of the supporting salt include fluorine-containing lithium salts such as lithium hexafluorophosphate (LiPF₆), and lithium bis(fluorosulfonyl)imide (LiFSI). The nonaqueous electrolyte solution may additionally contain an additive as necessary. The nonaqueous electrolyte solution is typically a liquid type, and may be a gel type. In another embodiment, the power storage device 100 may include a solid electrolyte instead of the nonaqueous electrolyte solution. In this case, the separator 26 can be omitted.

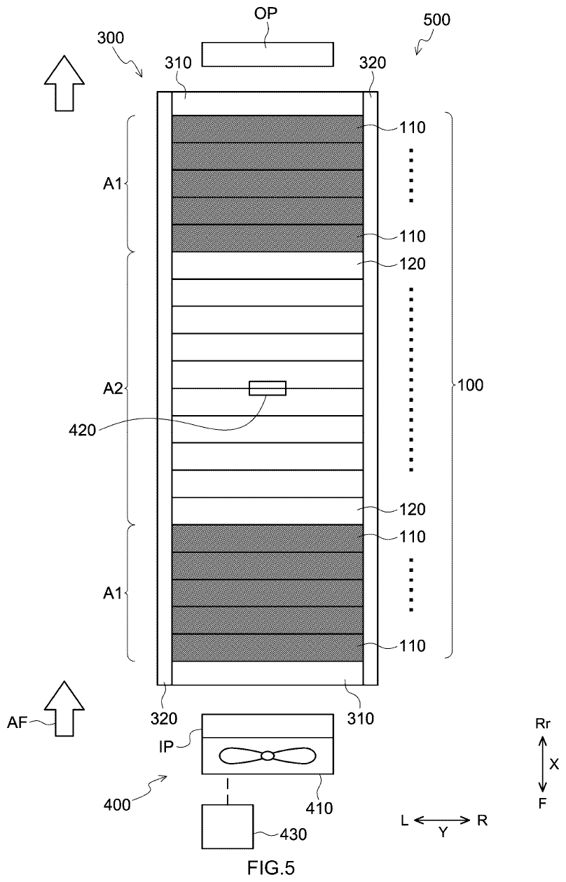

FIG. 5 is a plan view schematically illustrating the power storage module 500 and a cooling device 400. Note that FIG. 5 does not illustrate the details of the spacer 200 and an upper surface of the power storage device 100. As illustrated in FIG. 5, the cooling device 400 here includes an intake port IP, an exhaust port OP, an air-cooling fan 410, a temperature sensor 420, and a control device 430. The cooling device 400 is an air-cooling type cooling device that uses air as a coolant here. However, in another embodiment, the cooling device 400 may be a liquid-cooling type cooling device using a liquid coolant.

In this embodiment, the intake port IP is provided on one side (front F side) of the power storage module 500 in the arrangement direction X. The exhaust port OP is provided on the other side (rear Rr side) in the arrangement direction X. The air-cooling fan 410 is attached to the intake port IP. The air-cooling fan 410 is configured to supply wind (air) to the intake port IP. The structure of the air-cooling fan 410 is not limited and, for example, includes an electric motor (not illustrated). The temperature sensor 420 is disposed at a central part of an XY plane of the power storage module 500 here. The temperature sensor 420 is, for example, a thermocouple, a thermistor, or the like.

The control device 430 is electrically connected to the temperature sensor 420 and the electric motor of the air-cooling fan 410. When the temperature sensor 420 detects that the temperature inside the power storage module 500 becomes a predetermined first temperature or more, for example, the control device 430 operates the air-cooling fan 410. Thus, air with low temperature outside the power storage module 500 is supplied into the power storage module 500 through the intake port IP, so that an air flow AF is generated inside the power storage module 500. The supplied air passes inside the power storage module 500 while cooling the power storage devices 100, and is discharged through the exhaust port OP. When the temperature sensor 420 detects that the temperature in the power storage module 500 becomes a predetermined second temperature or less, for example, the control device 430 stops the air-cooling fan 410. With the air-cooling type cooling device 400 described above, the power storage device 100 can be cooled at low cost.

Incidentally, according to the present inventors' examination, a temperature distribution can occur inside the power storage module 500 having a cooling mechanism, for example the cooling device 400, when the plurality of power storage devices 100 are charged and discharged, and accordingly, a low-temperature region A1 where the temperature is relatively low and a high-temperature region A2 where the temperature is relatively high can be generated. Specifically, as the power storage device 100 generates heat along with the charging and discharging, the adjacent power storage devices 100 generate heat mutually. Thus, at a central part in the arrangement direction X, heat is generated from the power storage devices 100 successively and the temperature tends to become high relatively. On the other hand, at both end parts in the arrangement direction X (front F part and rear Rr part in FIG. 5), the heat dissipation is higher than at the central part and the successive heat generation does not occur easily. Thus, at the both end parts in the arrangement direction X, the temperature tends to become low relatively.

In particular, in this embodiment, the intake port IP through which the coolant (air) is supplied and the air-cooling fan 410 are disposed on the front F side in the arrangement direction X and the exhaust port OP is disposed on the rear Rr side in the arrangement direction X. Accordingly, the temperature tends to become low at the both end parts in the arrangement direction X. Thus, the central part in the arrangement direction X tends to become the high-temperature region A2 where the temperature is relatively high and the both end parts in the arrangement direction X (front F part and rear Rr part in FIG. 5) tend to become the low-temperature regions A1 where the temperature is relatively low. In particular, the front F part in the arrangement direction X where the intake port IP and the air-cooling fan 410 are disposed tends to have the lowest temperature. That is to say, in this embodiment, at least the front F side in the arrangement direction X tends to become the low-temperature region A1 where the temperature is relatively low.

For example, as also described in Japanese Patent Application Publication No. 2021-44212 and the like, if the temperature distribution occurs inside the power storage module 500, variation may occur in high-rate durability of the power storage devices 100. Specifically, the high-rate durability of the power storage devices 100 may decrease in the low-temperature region A1. In this case, if charging and discharging of the entire power storage module 500 are controlled based on the high-rate durability of the power storage devices 100 in the low-temperature region A1, the high high-rate durability of the power storage devices 100 in the high-temperature region A2 cannot be utilized sufficiently. On the other hand, if based on the high-rate durability of the power storage devices 100 in the high-temperature region A2, high voltage is applied to the power storage devices 100 in the low-temperature region A1 and high-rate deterioration tends to accelerate. In this manner, if the temperature distribution occurs inside the power storage module 500, the high-rate durability of the entire power storage module 500 may decrease following the high-rate durability of the power storage devices 100 in the low-temperature region A1. In a case where the power storage module is mounted on the moving body such as a vehicle, the fuel efficiency may deteriorate.

In view of this, first power storage devices 110 and second power storage devices 120 that are different from each other in terms of the filling density (solid content density) of the negative electrode active material layer 24a are used as the plurality of power storage devices 100 in the art disclosed herein. In the first power storage device 110, the filling density of the negative electrode active material layer 24a is lower than that in the second power storage device 120. The present inventors' examination indicates that the power storage device 100 in which the filling density of the negative electrode active material layer 24a is lower has higher high-rate durability, which will be described in detail below. Therefore, in this embodiment, the first power storage devices 110 in which the filling density of the negative electrode active material layer 24a is relatively low (high-rate durability is high) are disposed in the low-temperature regions A1 with the relatively low temperature, which are the both end parts in the arrangement direction X (front F part and rear Rr part in FIG. 5) here. Moreover, the second power storage devices 120 in which the filling density of the negative electrode active material layer 24a is relatively high (high-rate durability is low) are disposed in the high-temperature region A2 with the relatively high temperature, which is the central part in the arrangement direction X here.

With such a structure, the high-rate durability of the plurality of power storage devices 100 can be equalized at a high level. Additionally, the acceleration of deterioration can be suppressed and the high-rate durability of the entire power storage module 500 can be improved. Since it is unnecessary to consider the concept of “cell group” that is given in the art disclosed in Japanese Patent Application Publication No. 2021-44212, the high-rate durability of the plurality of power storage devices 100 can be flexibly adjusted in accordance with the temperature distribution inside the power storage module 500. Therefore, the high-rate durability of the plurality of power storage devices 100 may be equalized with high accuracy compared to the art disclosed in Japanese Patent Application Publication No. 2021-44212. Moreover, the number of restriction mechanisms 300 can be reduced compared to the art disclosed in Japanese Patent Application Publication No. 2021-44212; thus, the volume energy density or the fuel efficiency can also be improved. Additionally, by reducing the number of components, the manufacturing cost can be reduced.

Note that the filling density of the negative electrode active material layer 24a can be adjusted relatively easily by changing conditions in a pressing process (particularly, pressing pressure) in a (A-1) negative electrode manufacturing step in a manufacturing method to be described below, for example.

In the case where the plurality of first power storage devices 110 and the plurality of second power storage devices 120 exist as described in this embodiment, it is preferable that the filling density of the negative electrode active material layer 24a be lower in each of the plurality of first power storage devices 110 than in the plurality of second power storage devices 120. Although not limited in particular, the filling density of the negative electrode active material layer 24a is preferably in the range of about 1 to 2 g/cm³ and more preferably in the range of 1.0 to 1.6 g/cm³ in both the first power storage devices 110 and the second power storage devices 120 from the viewpoint of making the energy density and the high-rate durability balanced at a high level. In particular, when the filling density is a predetermined value or less, the high-rate charging characteristic of the power storage module 500 can be improved.

In one embodiment, the filling density of the negative electrode active material layer 24a in the first power storage device 110 is preferably about 1.5 g/cm³ or less, and for example in the range of 1.0 to 1.3 g/cm³ although depending on the temperature distribution inside the power storage module 500. The filling density of the negative electrode active material layer 24a in the second power storage device 120 is preferably about 2.0 g/cm³ or less, and for example in the range of 1.3 to 1.6 g/cm³.

The difference in filling density between the negative electrode active material layer 24a of the first power storage device 110 and the negative electrode active material layer 24a of the second power storage device 120 is a design matter that is adjusted as appropriate based on the temperature distribution inside the power storage module 500 or the like, for example. Therefore, although not limited in particular, in the case where the temperature distribution is largely different between the first power storage devices 110 and the second power storage devices 120, for example, the difference in filling density between the negative electrode active material layer 24a of the first power storage device 110 and the negative electrode active material layer 24a of the second power storage device 120 is preferably 0.1 g/cm³ or more, more preferably 0.2 g/cm³ or more, and may be 0.4 g/cm³ or more, for example. When the difference in filling density is a predetermined value or more, the effect of the art disclosed herein can be achieved more remarkably. The difference in filling density may be 1 g/cm³ or less, or 0.5 g/cm³ or less, for example. Thus, the high-rate charging characteristic can be equalized with high accuracy between the first power storage devices 110 and the second power storage devices 120. Note that if the plurality of first power storage devices 110 and the plurality of second power storage devices 120 exist, the difference in filling density may be the difference between the average filling density of the plurality of first power storage devices 110 and the average filling density of the plurality of second power storage devices 120.

In one embodiment, the negative electrode active material layer 24a of the first power storage device 110 is preferably formed relatively thick because of having the low filling density, for example, and the negative electrode active material layer 24a of the second power storage device 120 is preferably formed relatively thin because of having the high filling density, for example. The first power storage devices 110 and the second power storage devices 120 are preferably configured so that the basis weight of the negative electrode active material layer 24a (the mass of the negative electrode active material layer 24a per unit area of the negative electrode current collector 24c) is the same and the negative electrode capacity is equal (error in manufacture or the like is allowable). Thus, the energy density can be equalized between the first power storage devices 110 and the second power storage devices 120 and the high energy density as the entire power storage module 500 can be achieved.

In one embodiment, the first power storage devices 110 and the second power storage devices 120 preferably include the same kind of negative electrode active material, and preferably have the same structure of, for example, the positive electrode 22, the separator 26, and the nonaqueous electrolyte solution in addition to the negative electrode active material layer 24a. Thus, the battery performance other than the high-rate durability can be easily equalized between the first power storage devices 110 and the second power storage devices 120.

### [Manufacturing Method for Power Storage Module]

Next, the manufacturing method for the power storage module 500 including the plurality of power storage devices 100 is described. For example, the power storage module 500 can be manufactured by the manufacturing method including the following steps: (step A) a preparing step of preparing the first power storage devices 110 and the second power storage devices 120; (step B) a temperature distribution predicting step of predicting the temperature distribution inside the power storage module 500; and (step C) a constructing step of constructing the power storage module 500 by combining the first power storage devices 110 and the second power storage devices 120. Note that the order of (step A) the preparing step and (step B) the temperature distribution predicting step is not limited in particular and for example, (step B) the temperature distribution predicting step may be performed after (step A) the preparing step, (step A) the preparing step may be performed after (step B) the temperature distribution predicting step, or both steps may be performed at the same time. The manufacturing method disclosed herein may further include another step at an optional stage.

In (step A) the preparing step, the first power storage devices 110 in which the filling density of the negative electrode active material layer 24a is relatively low and the second power storage devices 120 in which the filling density of the negative electrode active material layer 24a is relatively high are prepared as the plurality of power storage devices 100. In this embodiment, (step A) the preparing step includes (A-1) the negative electrode manufacturing step of manufacturing the negative electrode 24, (A-2) an electrode body manufacturing step of manufacturing the electrode body 20 using the negative electrode 24, (A-3) an accommodating step of accommodating the electrode body 20 and the nonaqueous electrolyte solution in the battery case 10, and (A-4) a conditioning step in this order.

In (A-1) the negative electrode manufacturing step, at least two kinds of negative electrodes 24 in which the filling density of the negative electrode active material layer 24a is different are manufactured. Specifically, a first negative electrode for the first power storage device 110, in which the filling density is relatively low, and a second negative electrode for the second power storage device 120, in which the filling density is relatively high, are manufactured. Specifically, for example, first, solid content materials as described above (for example, negative electrode active material, binder, thickener, and the like) are dispersed in a predetermined solvent (for example, water, N-methyl-2-pyrrolidone, or the like), so that a negative electrode mixture paste including at least the negative electrode active material is prepared. Next, the prepared negative electrode mixture paste is applied and dried on a surface of the negative electrode current collector 24c using a conventionally known applying device. Thus, the negative electrode mixture is fixed on the surface of the negative electrode current collector 24c. Here, the amount of applying negative electrode mixture paste per unit area is preferably the same between the first negative electrode and the second negative electrode.

Next, the negative electrode current collector 24c where the negative electrode mixture is fixed is subjected to the pressing process. At this time, by changing conditions in the pressing process (for example, pressing pressure or holding time), the filling density of the negative electrode active material layer 24a is adjusted. For example, the pressing pressure is lower in the first negative electrode for the first power storage device 110 than in the second negative electrode for the second power storage device 120. Thus, the filling density of the negative electrode active material layer 24a is relatively low (and the negative electrode active material layer 24a is relatively thick) in the first negative electrode and the filling density of the negative electrode active material layer 24a is relatively high (and the negative electrode active material layer 24a is relatively thin) in the second negative electrode. In this manner, the first negative electrode and the second negative electrode including the negative electrode active material layer 24a with the different filling densities can be manufactured.

In (A-2) the electrode body manufacturing step, each of the first negative electrode and the second negative electrode manufactured in the negative electrode manufacturing step is disposed to face the positive electrode 22 prepared separately through the separator 26 as described above, and wound. Thus, the electrode body 20 for the first power storage device 110 and the electrode body 20 for the second power storage device 120 are manufactured.

In (A-3) the accommodating step, the electrode body 20 manufactured in the electrode body manufacturing step and the nonaqueous electrolyte solution as described above are accommodated in the battery case 10. In a preferred embodiment, first, the positive electrode tab group 23 of the electrode body 20 is joined to the positive electrode current collecting part 50 and the negative electrode tab group 25 of the electrode body 20 is joined to the negative electrode current collecting part 60. Thus, the sealing plate 14 and the electrode body 20 are integrated. Next, the opening 12h of the exterior body 12 is covered with the sealing plate 14 and the electrode body 20 is disposed inside the exterior body 12. Subsequently, the sealing plate 14 is welded to the periphery of the opening 12h of the exterior body 12 to integrate the exterior body 12 and the sealing plate 14. Then, the nonaqueous electrolyte solution as described above is prepared and injected into the battery case 10 through the liquid injection hole 15 of the sealing plate 14. Thus, a battery assembly for the first power storage device 110 and the battery assembly for the second power storage device 120 are manufactured.

In (A-4) the conditioning step, the manufactured battery assembly is charged at least once. The manufactured battery assembly is preferably charged and discharged at least once. The battery assembly can be charged and discharged similarly to the conventional charging and discharging. Typically, an external power source is connected between the positive electrode terminal 30 and the negative electrode terminal 40, and charging or discharging is performed until a predetermined state of charge (SOC) is achieved between the terminals. Then, the battery case 10 is hermetically sealed (closed). In this manner, the first power storage devices 110 and the second power storage devices 120 in which the filling density of the negative electrode active material layer 24a is different can be prepared.

In (step B) the temperature distribution predicting step, the temperature distribution inside the power storage module 500 when the plurality of power storage devices 100 are charged and discharged is predicted. That is to say, in an aspect illustrated in FIG. 5, for example, both end parts in the arrangement direction X (front F part in the arrangement direction X in particular) tend to become the low-temperature regions A1. The temperature distribution inside the power storage module 500, however, can change depending on the structure of the cooling device 400 (for example, the installation positions or the number of intake ports IP, exhaust ports OP, and air-cooling fans 410) or a heat dissipation route. Additionally, the range of the low-temperature region A1 (the length in the arrangement direction X), for example, can also change depending on the number of power storage devices 100, the charging and discharging conditions, and the like. Accordingly, it is preferable to predict the temperature distribution inside the power storage module 500 at the charging and discharging by preliminary experiments, simulation using commercial analysis software, or the like. In particular, it is preferable to measure the temperature distribution actually by constructing the power storage module for preliminary tests for simulating the power storage module 500, and predict the temperature distribution inside the power storage module 500 on the basis of the actual measurements.

In a preferred embodiment, first, a plurality of power storage devices for the preliminary tests, which are different from the first power storage devices 110 and the second power storage devices 120 manufactured in the preparing step, are prepared and a temperature sensor is attached to each of the plurality of power storage devices. Next, using the plurality of power storage devices for the preliminary tests, the power storage module for the preliminary tests for simulating the power storage module 500 is assembled. Next, the plurality of power storage devices for the preliminary tests are actually charged and discharged (preferably charged and discharged at a high rate) and the temperature distributions at this time are acquired. The charging and discharging conditions are preferably the conditions in consideration of the mode of the actual use. Then, based on the acquired temperature distributions, the temperature distribution inside the power storage module 500 is predicted and the inside of the power storage module 500 is sectioned into, for example, the low-temperature region A1 and the high-temperature region A2 (for example, divided into two).

In (step C) the constructing step, the first power storage devices 110 and the second power storage devices 120 are disposed to construct the power storage module 500 on the basis of the temperature distribution predicted in the temperature distribution predicting step. Specifically, in a region sectioned as the low-temperature region A1, the first power storage devices 110 in which the filling density of the negative electrode active material layer 24a is relatively low are disposed and in a region sectioned as the high-temperature region A2, the second power storage devices 120 in which the filling density of the negative electrode active material layer 24a is relatively high are disposed. Then, the first power storage devices 110 and the second power storage devices 120 are restricted by the restriction mechanism 300 together with the plurality of spacers 200, for example, and are held integrally. The power storage module 500 can be constructed as above.

### [Application of Power Storage Module]

The power storage module 500 can be used for various applications, but since the power storage module 500 has the excellent high-rate durability, the power storage module 500 can be suitably used in an application in which high output is needed, for example, as a motive power source for a motor (power source for driving) that is mounted on a vehicle such as a passenger car or a truck. The vehicle is not limited to a particular type, and may be, for example, a plug-in hybrid electric vehicle (PHEV), a hybrid electric vehicle (HEV), or a battery electric vehicle (BEV). By mounting the power storage module 500 on the moving body such as a vehicle, the fuel efficiency (electricity efficiency) of the moving body can be improved.

Several test examples relating to the present disclosure will be explained below, but the present disclosure is not meant to be limited to these test examples.

In these test examples, the power storage devices in which the filling density of the negative electrode active material layer was different were constructed and the high-rate durability was checked. Specifically, first, the negative electrodes including the negative electrode active material layers with the filling densities shown in Table 1 were manufactured and the power storage devices (lithium ion secondary batteries, Examples 1 to 5) were manufactured using the negative electrodes. Note that the filling density was adjusted by changing the pressing pressure in the pressing process. In order to homogenize the negative electrode capacity, the negative electrode active material layers had the equal basis weight. Therefore, the thicknesses of the negative electrode active material layers were different from each other among Examples 1 to 5 (specifically, the negative electrode active material layer was thicker as the power storage device had the lower filling density); however, the other structure is common among the entire power storage devices. Next, under an environment with a temperature of 25° C., the SOC of the power storage device was adjusted to 50% and constant-current discharging was performed at 150 A for 10 seconds; then, the discharging resistance was measured. Subsequently, a battery voltage ΔV dropped in 10 seconds was read and based on the battery voltage ΔV and the discharging current value (150 A), IV resistance (initial resistance) was calculated.

Next, under the environment with a temperature of 25° C., the SOC of the power storage device was adjusted to 50%, constant-current charging was performed at a charging rate of 150 A for 10 seconds, which was followed by 5-second rest, and then constant-current discharging was performed at a discharging rate of 10 A for 150 seconds, which was followed by 5-second rest. These charging and discharging are regarded as one cycle, and 1000 cycles were repeated to perform the high-rate durability test. After the high-rate durability test, the IV resistance was measured similarly to the initial resistance, and from the ratio of the IV resistance after the durability test to the initial resistance (IV resistance after the durability test/initial resistance), the resistance increase rate was calculated. The results are shown in Table 1. Note that Table 1 shows the relative values when the resistance increase rate in Example 2 is 1.00 (standard).

TABLE 1

| | | | High-rate |
|---|---|---|---|
| | Pressing | Filling density | durability, |
| | pressure in | of negative | resistance |
| | pressing | electrode active | increase rate |
| | process | material layer | (relative value) |
| Example 1 | Very low | 1.0 g/cm³ | 0.96 |
| Example 2 | Low | 1.1 g/cm³ | 1.00 (standard) |
| Example 3 | Middle | 1.3 g/cm³ | 1.11 |
| Example 4 | High | 1.5 g/cm³ | 1.16 |
| Example 5 | Very high | 1.6 g/cm³ | 1.32 |

As shown in Table 1, in the power storage device in which the filling density of the negative electrode active material layer was lower, the increase in resistance after the high-rate durability test was suppressed to be smaller, in other words, the high-rate durability was higher. Although it is not intended to limit the interpretation in particular, the reasons are considered as follows: as the filling density of the negative electrode is lower, the transfer of the electrolyte solution (liquid flow) in the negative electrode particularly at the high-rate charging is improved and even after the high-rate charging and discharging are repeated, the resistance does not increase easily. Accordingly, the experiment results have also proved that the power storage device in which the filling density of the negative electrode active material layer is lower is relatively superior to the power storage device in which the filling density of the negative electrode active material layer is higher in terms of the high-rate durability.

Although the preferable embodiments of the present disclosure have been described above, they are merely examples. The present disclosure can be implemented in various other modes. The present disclosure can be implemented based on the contents disclosed in the present specification and the technical common sense in the relevant field. The techniques described in the scope of claims include those in which the embodiments exemplified above are variously modified and changed. For example, another modification can replace a part of the aforementioned embodiment or be added to the aforementioned embodiment. Additionally, the technical feature may be deleted as appropriate unless such a feature is described as an essential element.

(1) For example, in the aforementioned embodiment, in (step A) the preparing step, the power storage devices 100 in which the filling density of the negative electrode active material layer 24a was varied on purpose were manufactured. However, the present disclosure is not limited to this. In another example, the first power storage devices 110 and the second power storage devices 120 can be selected and prepared in a predetermined range of good products from a number of power storage devices in which the filling density of the negative electrode active material layer 24a varies.

Specific examples include a case where used power storage devices (which may be in the state of the power storage module) are collected from the market and reused, that is, the power storage devices 100 are the reused products. In recent years, some power storage devices such as a lithium ion secondary battery may have identification information from the viewpoint of traceability or the like. In one example, an optical symbol that is readable by a reading device is given on a surface of the power storage module (for example, sealing plate 14). Alternatively, a small substrate including identification information is mounted inside the power storage device, for example. The identification information may include, for example, ID information such as a model number, the names of a manufacturer, a country of manufacture, and a factory of manufacture, and the date of manufacture and additionally, the material information such as the kind of negative electrode active material or the filling density of the negative electrode active material layer 24a.

In this case, (step A) the preparing step may include (1-a) an acquiring step of reading out the identification information given to a number of collected power storage devices and acquiring information about the filling density of the negative electrode active material layer 24a and (1-b) a selecting step of selecting the first power storage devices 110 in which the filling density of the negative electrode active material layer 24a is relatively low and the second power storage devices 120 in which the filling density of the negative electrode active material layer 24a is relatively high, based on the acquired information about the filling density. The manufacturing method for the power storage module as described above can be grasped as a method of reusing the power storage device. Note that in the present specification, the term “optical symbol” is a generic term of information media that store information by a combination of a part with high optical reflectivity and a part with low optical reflectivity, and is a concept encompassing two-dimensional symbols (also referred to as two-dimensional code, two-dimensional barcode, or the like) such as QR code (registered trademark), data matrix, and data tags.

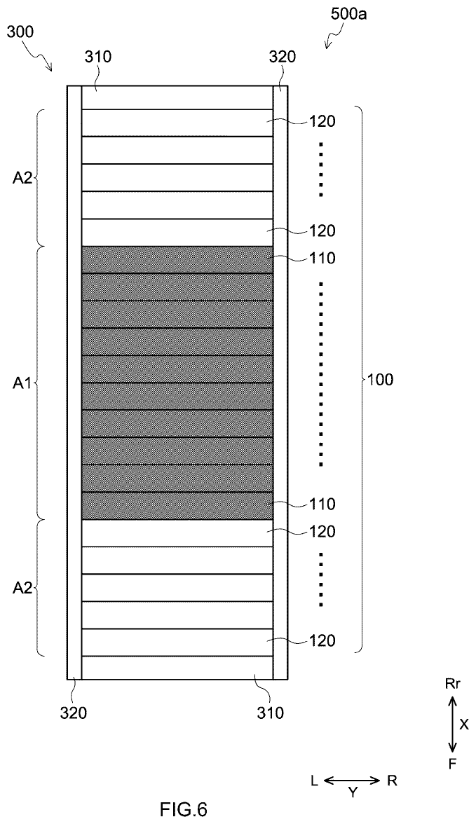

(2) In the aforementioned embodiment in FIG. 5, for example, the both end parts in the arrangement direction X (front F part and rear Rr part in FIG. 5) are the low-temperature regions A1 with the relatively low temperature and the central part in the arrangement direction X is the high-temperature region A2 with the relatively high temperature. However, the present disclosure is not limited to this. As described above, the temperature distribution inside the power storage module 500 can vary depending on the structure of the cooling device 400 (for example, the installation position and the number of intake ports IP, exhaust ports OP, and air-cooling fans 410), the number of power storage devices 100, the charging and discharging conditions, and the like. In the aforementioned embodiment in FIG. 5, the inside of the power storage module 500 is sectioned into the two temperature regions, the low-temperature regions A1 and the high-temperature region A2, with the temperature distribution symmetrical in the arrangement direction X. However, the present disclosure is not limited to this. For example, the inside of the power storage module 500 may be sectioned into three or more temperature regions. In this case, in the embodiment in FIG. 5, the low-temperature region A1 on the rear Rr side in the arrangement direction X may be a middle-temperature region A3 in which the temperature is higher than that in the low-temperature region A1 and lower than that in the high-temperature region A2. In a case where a cooling route or a heat dissipation route is complicated, the temperature distribution may be random; for example, the low-temperature regions A1 and the high-temperature regions A2 may appear alternately. Some specific modifications will hereinafter be described with reference to FIG. 6 to FIG. 9. Note that the illustration of the cooling device is omitted in FIG. 6 to FIG. 9.

### First Modification

FIG. 6 is a plan view of a power storage module 500a according to a first modification. As described above, it has been known that the successive heat generation easily occurs in the power storage devices 100 at the central part in the arrangement direction X. Therefore, although the illustration is omitted in FIG. 6, the intake port IP through which the coolant (air) is supplied and/or the air-cooling fan 410 may be added at the central part in the arrangement direction X so that the central part is cooled intensively. In this case, as illustrated in FIG. 6, the temperature distribution of the power storage module 500a includes the low-temperature region A1 with the relatively low temperature at the central part in the arrangement direction X and the high-temperature regions A2 with the relatively high temperature at the both end parts in the arrangement direction X (front F part and rear Rr part in FIG. 6), which is opposite to the arrangement in FIG. 5.

In this case, for example, as illustrated in FIG. 6, the first power storage devices 110 in which the filling density of the negative electrode active material layer 24a is relatively low (high-rate durability is high) are preferably disposed at the central part in the arrangement direction X, which is the low-temperature region A1, and the second power storage devices 120 in which the filling density of the negative electrode active material layer 24a is relatively high (high-rate durability is low) are preferably disposed at the both end parts in the arrangement direction X, which are the high-temperature regions A2.

### Second and Third Modifications

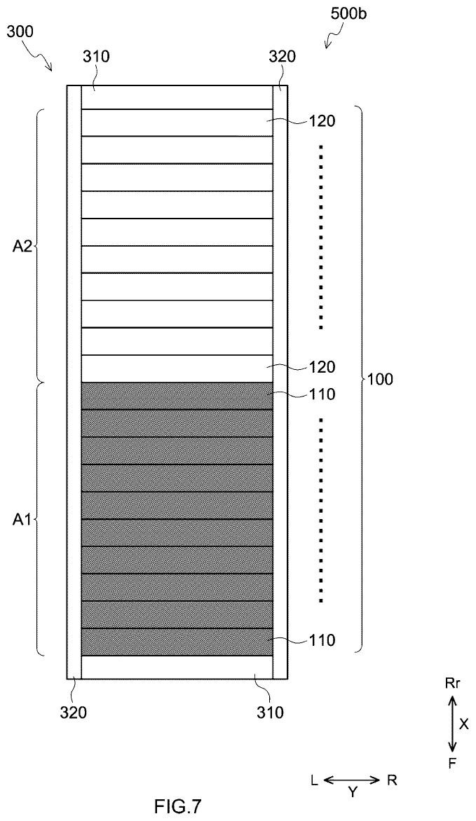

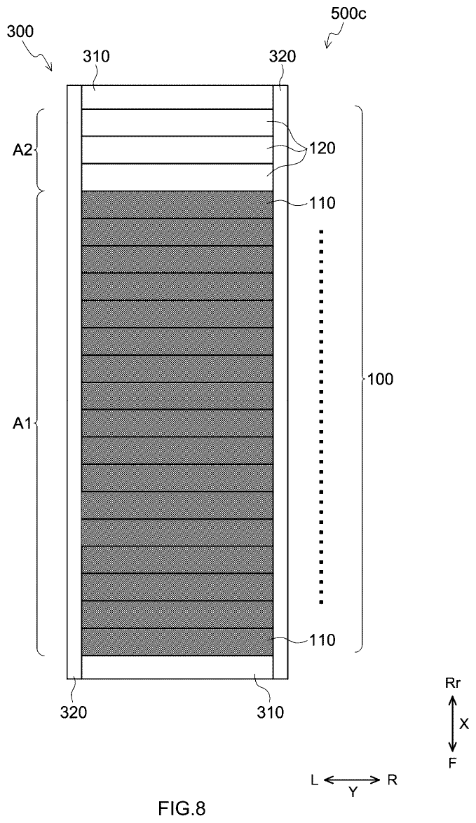

FIG. 7 is a plan view of a power storage module 500b according to a second modification. FIG. 8 is a plan view of a power storage module 500c according to a third modification. For example, in a case where the air-cooling fan 410 disposed on the front F side in the arrangement direction X in FIG. 5 has high power and high cooling capability, the temperature distribution in the power storage modules 500b and 500c include the low-temperature region A1 with the relatively low temperature in the front F part in the arrangement direction X and the high-temperature region A2 with the relatively high temperature in the rear Rr part in the arrangement direction X as illustrated in FIG. 7 and FIG. 8.

In these cases, for example, as illustrated in FIG. 7 and FIG. 8, the first power storage devices 110 in which the filling density of the negative electrode active material layer 24a is relatively low (high-rate durability is high) are preferably disposed in the front F part in the arrangement direction X, which is the low-temperature region A1, and the second power storage devices 120 in which the filling density of the negative electrode active material layer 24a is relatively high (high-rate durability is low) are preferably disposed in the rear Rr part in the arrangement direction X, which is the high-temperature region A2.

The allocation of the low-temperature region A1 and the high-temperature region A2 may vary depending on, for example, the number of power storage devices 100, the charging and discharging conditions, and the like. Therefore, the low-temperature region A1 and the high-temperature region A2 may be provided uniformly in the arrangement direction X as illustrated in FIG. 7 or may be provided non-uniformly in the arrangement direction X as illustrated in FIG. 8. In other words, the number of first power storage devices 110 and the number of second power storage devices 120 in the power storage module 500 may be either the same or different.

### (Fourth Modification)

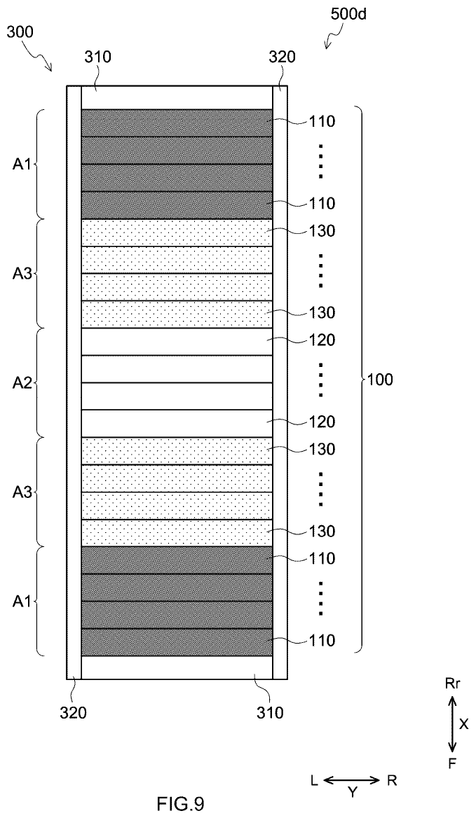

FIG. 9 is a plan view of a power storage module 500d according to a fourth modification. As illustrated in FIG. 9, here, the temperature distribution of the power storage module 500d is sectioned in more detail than in FIG. 5. That is to say, the low-temperature regions A1 with the relatively low temperature are formed at the both end parts in the arrangement direction X (front F part and rear Rr part in FIG. 6), the high-temperature region A2 with the relatively high temperature is formed at the central part in the arrangement direction X, and the middle-temperature regions A3 with the temperature higher than that in the low-temperature region A1 and lower than that in the high-temperature region A2 are formed between the low-temperature regions A1 and the high-temperature region A2.

In this case, for example, as illustrated in FIG. 9, the first power storage devices 110 in which the filling density of the negative electrode active material layer 24a is relatively low (high-rate durability is high) are preferably disposed at the both end parts in the arrangement direction X, which are the low-temperature regions A1, the second power storage devices 120 in which the filling density of the negative electrode active material layer 24a is relatively high (high-rate durability is low) are preferably disposed at the central part in the arrangement direction X, which is the high-temperature region A2, and third power storage devices 130 in which the filling density of the negative electrode active material layer 24a is lower than that in the second power storage devices 120 and higher than that in the first power storage devices 110 are preferably disposed in the middle-temperature regions A3 between the low-temperature regions A1 and the high-temperature region A2. In other words, the plurality of power storage devices 100 are preferably disposed so that the filling density of the negative electrode active material layer 24a gradually decreases in the order of the high-temperature region A2, the middle-temperature region A3, and the low-temperature region A1, that is, from the central part to the both end parts in the arrangement direction X here.

Note that although the inside of the power storage module 500 is sectioned into three temperature regions in FIG. 9, the inside of the power storage module 500 may be sectioned into four or more temperature regions. By sectioning the inside of the power storage module 500 in detail in accordance with the temperature distribution in this manner, the effect of the art disclosed herein can be achieved at the high level and the high-rate durability of the entire power storage module 500 can be improved further.

As described above, the following items are given as specific aspects of the art disclosed herein.
Item 1: The power storage module including the plurality of power storage devices, in which each of the plurality of power storage devices includes the positive electrode and the negative electrode, the negative electrode includes the negative electrode active material layer including the negative electrode active material, the low-temperature region with relatively low temperature and the high-temperature region with relatively high temperature exist in the power storage module when the plurality of power storage devices are charged and discharged, and in the first power storage device disposed in the low-temperature region among the plurality of power storage devices, the filling density of the negative electrode active material layer is lower than that in the second power storage device disposed in the high-temperature region.
Item 2: The power storage module according to Item 1, in which the middle-temperature region with the temperature higher than the temperature in the low-temperature region and lower than the temperature in the high-temperature region exists between the low-temperature region and the high-temperature region inside the power storage module, and the plurality of power storage devices are disposed so that the filling density of the negative electrode active material layer gradually decreases in the order of the high-temperature region, the middle-temperature region, and the low-temperature region.
Item 3: The power storage module according to Item 1 or 2, in which the filling density of the negative electrode active material layer is in the range of 1.0 g/cm³ or more and 1.6 g/cm³ or less in both the first power storage device and the second power storage device.
Item 4: The power storage module according to any one of Items 1 to 3, in which the negative electrode active material layer is thicker in the first power storage device than in the second power storage device.
Item 5: The power storage module according to any one of Items 1 to 4, in which the first power storage device and the second power storage device are connected in series.
Item 6: The manufacturing method for the power storage module including the plurality of power storage devices, in which each of the plurality of power storage devices includes the positive electrode and the negative electrode and the negative electrode includes the negative electrode active material layer including the negative electrode active material, the manufacturing method including: the preparing step of preparing, as the plurality of power storage devices, the first power storage device in which the filling density of the negative electrode active material layer is relatively low and the second power storage device in which the filling density of the negative electrode active material layer is relatively high; the temperature distribution predicting step of predicting the temperature distribution inside the power storage module when the plurality of power storage devices are charged and discharged; and the constructing step of constructing the power storage module by disposing the first power storage device in the low-temperature region with relatively low temperature and disposing the second power storage device in the high-temperature region with relatively high temperature, based on the temperature distribution.

### REFERENCE SIGNS LIST

10 Battery case
20 Electrode body
24 Negative electrode
100 Power storage device
110 First power storage device
120 Second power storage device
130 Third power storage device
300 Restriction mechanism
400 Cooling device
410 Air-cooling fan
500 Power storage module
A1 Low-temperature region
A2 High-temperature region
A3 Middle-temperature region

What is claimed is:

1. A power storage module comprising a plurality of power storage devices, wherein
each of the plurality of power storage devices includes a positive electrode and a negative electrode,
the negative electrode includes a negative electrode active material layer including a negative electrode active material,
a low-temperature region with relatively low temperature and a high-temperature region with relatively high temperature exist in the power storage module when the plurality of power storage devices are charged and discharged, and
in a first power storage device disposed in the low-temperature region among the plurality of power storage devices, a filling density of the negative electrode active material layer is lower than that in a second power storage device disposed in the high-temperature region.

2. The power storage module according to claim 1, wherein
a middle-temperature region with temperature higher than the temperature in the low-temperature region and lower than the temperature in the high-temperature region exists between the low-temperature region and the high-temperature region inside the power storage module, and
the plurality of power storage devices are disposed so that the filling density of the negative electrode active material layer gradually decreases in order of the high-temperature region, the middle-temperature region, and the low-temperature region.

3. The power storage module according to claim 1, wherein the filling density of the negative electrode active material layer is in a range of 1.0 g/cm³ or more and 1.6 g/cm³ or less in both the first power storage device and the second power storage device.

4. The power storage module according to claim 1, wherein the negative electrode active material layer is thicker in the first power storage device than in the second power storage device.

5. The power storage module according to claim 1, wherein the first power storage device and the second power storage device are connected in series.

6. A manufacturing method for a power storage module including a plurality of power storage devices, in which each of the plurality of power storage devices includes a positive electrode and a negative electrode and the negative electrode includes a negative electrode active material layer including a negative electrode active material, the manufacturing method comprising:
a preparing step of preparing, as the plurality of power storage devices, a first power storage device in which a filling density of the negative electrode active material layer is relatively low and a second power storage device in which the filling density of the negative electrode active material layer is relatively high;
a temperature distribution predicting step of predicting a temperature distribution inside the power storage module when the plurality of power storage devices are charged and discharged; and
a constructing step of constructing the power storage module by disposing the first power storage device in a low-temperature region with relatively low temperature and disposing the second power storage device in a high-temperature region with relatively high temperature, based on the temperature distribution.
